(19) United States
(12) Patent Application Publication
(10) Pub. No.: US 2025/0043392 A1
(43) Pub. Date: Feb. 6, 2025

(54) METHOD OF MAKING AN ALUMINUM-CUBIC BORON NITRIDE (Al-cBN) COMPOSITE

(71) Applicant: KING FAHD UNIVERSITY OF PETROLEUM AND MINERALS, Dhahran (SA)

(72) Inventors: Abbas Saeed HAKEEM, Dhahran (SA); Muhammad Ali EHSAN, Dhahran (SA); Hafiz Muzammil IRSHAD, Dhahran (SA); Bilal Anjum AHMED, Dhahran (SA)

(73) Assignee: KING FAHD UNIVERSITY OF PETROLEUM AND MINERALS, Dhahran (SA)

(21) Appl. No.: 18/363,421

(22) Filed: Aug. 1, 2023

(51) Int. Cl. C22C 1/05; B22F 3/10; C04B 35/5831; C04B 35/626; C04B 35/645; C22C 21/00; C22C 26/00

(52) U.S. Cl. CPC C22C 1/05; B22F 3/10; C04B 35/5831; C04B 35/62655; C04B 35/645; C22C 21/00; C22C 26/00; B22F 2005/001; B22F 2998/10; B23B 2222/04; B23B 2226/125; C04B 2235/402; C04B 2235/5436; C04B 2235/96

(57) ABSTRACT

A method of making an aluminum-cubic boron nitride (Al-cBN) composite includes mixing an aluminum powder and particles of cubic boron nitride (cBN) in a solvent and sonicating to form an Al-cBN mixture; drying the Al-cBN mixture to form a dried mixture powder; and sintering by pressing and heating the dried mixture powder to form the Al-cBN composite. The aluminum powder has an average particle size of 10 to 100 micrometers (μm). The cBN particles have an average particle size of from 10 to 100 μm, and are uniformly dispersed throughout the Al-cBN composite.

### STATEMENT OF ACKNOWLEDGEMENT

Support provided by the Interdisciplinary Research Center for Hydrogen & Energy Storage (IRC-HES), at King Fahd University of Petroleum & Minerals (KFUPM), Dhahran, Saudi Arabia, is gratefully acknowledged.

### BACKGROUND

### Technical Field

The present disclosure is directed to an aluminum-based composite, particularly, to a method of making an aluminum-cubic boron nitride composite (Al-cBN).

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Metal matrix composites (MMCs) with synergistic metallic and ceramic properties are valuable for applications that prioritize low cost, lightweight construction, and high strength as essential material design parameters. Among metals and alloys, aluminum (Al) has attracted attention in the manufacturing of composite materials owing to its beneficial characteristics, including ease of processing and lower density compared to alternatives like grey cast iron and steel, and is therefore used in the automobile, aerospace, and many other industries. Al-based MMCs are promising materials for aerospace (e.g., fuselage, wings, and supporting structures in aircraft) and automotive applications (such as pistons, connecting rods, engine blocks, brake rotors, current collectors, propeller shafts, and brake disks). Their utilization contributes to weight reduction, fuel consumption reduction, and improved performance in oxidizing environments.

Composite materials possess a unique combination of properties, with ceramic-reinforced Al composites facilitating the design and development of materials tailored to specific applications, resulting in efficiency improvement and superior emission control compared to individual component materials. Ceramic particles introduce increased density and elastic modulus to the resulting composites. The selection and quantity of reinforcement materials within the matrix, as well as the matrix's interaction with the reinforcement, play a critical role in realizing the desired properties and overall performance of the composite. Therefore, various fabrication processes and reinforcements, such as SiC, WC, B4C, Al₂O₃, AlN, and other ceramics, have been employed in the development of Al-MMCs.

The selection of fabrication techniques for metal matrix composites (MMCs) is influenced by various factors, including production cost, process efficiency, and desired product quality. Among the commercially utilized techniques, liquid infiltration, stir casting, and powder metallurgy have been employed to produce MMCs. However, the powder metallurgy processing technique is promising due to its stability to offer better control over interface kinetics. Furthermore, it involves lower processing temperatures than casting and provides improved control over the resulting microstructures (uniform and fine microstructures). This enables accurate net shaping and improved material utilization. The powder metallurgy technique also allows for shorter sintering durations. Sintered aluminum (Al) composites developed through powder metallurgy processes exhibit potential for applications in automobile and aerospace industries. These composites possess a high strength-to-weight ratio and leverage the specific gravity advantages of aluminum [Koli, D. K., G. Agnihotri, and R. Purohit, Advanced aluminum matrix composites: the critical need of automotive and aerospace engineering fields. Materials Today: Proceedings, 2015. 2(4-5): p. 3032-3041; and Bishop, D., et al., On enhancing the mechanical properties of aluminum P/M alloys. Materials Science and Engineering: A, 2000. 290(1-2): p. 16-24]. Spark plasma sintering (SPS) may be used to strengthen the composites. The SPS is a non-conventional sintering technique in which materials in the form of powders are subjected to a combination of heat (generated by applying a high direct current) and uniaxial pressure to form coherent bodies with reduced porosities, increased densities, and improved mechanical and electrochemical properties, owing to the fine grain boundaries of composites.

Metal matrix composites (MMCs) are potential candidates for replacing metallic alloys in aerospace, automobile, and security applications due to their desirable characteristics such as corrosion resistance, high wear resistance, and thermal resistance. However, it is essential to carefully consider the corrosion behavior of MMCs when selecting them for specific applications and environmental conditions. One significant challenge associated with MMCs is the impact of reinforcement particles on their corrosion resistance properties. Even minor changes can have a significant effect on the long-term stability of their properties. Pardo et al. investigated the effect of SiC particles (10-20 vol. %) on the corrosion behavior of A360 and A380 prepared via a pressure die casting process in a NaCl solution (1 to 3.5 wt. %) [Pardo, A., et al., Influence of reinforcement proportion and matrix composition on pitting corrosion behavior of cast aluminum matrix composites (A3xx. x/SiCp). Corrosion Science, 2005. 47(7): p. 1750-1764]. Singh et al. studied the influence of SiC particles on an Al—Cu alloy fabricated using the stir-casting technique to examine its pitting susceptibility in a marine environment [Singh, I., et al., Influence of SiC particles addition on the corrosion behavior of 2014 Al—Cu alloy in 3.5% NaCl solution. Corrosion Science, 2009. 51(2): p. 234-241].

Acevedo-Hurtado et al. reported that increasing the percentage of Al₂O₃ particles in an Al—Al₂O₃ MMC decreases the corrosion rate in an aerated 3.5 wt. % NaCl solution. This composite material was fabricated using a powder metallurgy process, in which Al-alloyed powder and Al₂O₃ particles were first blended. Subsequently, the resulting materials were hot-consolidated and extruded to form a billet with a circular cross-section [Acevedo-Hurtado, P. and P. Sundaram, Corrosion behavior of novel Al—Al₂O₃ composites in aerated 3.5% chloride solution. Journal of Materials Engineering and Performance, 2017. 26(1): p. 69-75]. Ananda Murthy et al. investigated the influence of the TiN content (2 to 6 wt. %) on Al 6061 in a chloride medium (0.1 to 1N NaCl) [Murthy, H. A., V. B. Raju, and C. Shivakumara, Effect of TiN particulate reinforcement on corrosive behavior of aluminum 6061 composites in chloride medium. Bulletin of Materials Science, 2013. 36(6): p. 1057-1066]. Sherif et al. reported that the presence of exfoliated graphite (1-3 wt. %) in pure Al increases its corrosion rate [Sherif, E.-S. M., et al., Effects of graphite on the corrosion behavior of aluminum-graphite composite in sodium chloride solutions. Int. J. Electrochem. Sci, 2011. 6: p. 1085-1099].

However, there are still challenges that need to be overcome to further advance the commercial applications of aluminum-based composites. The cost-effectiveness and performance ratio of aluminum-based composites play a crucial role in their widespread industrial adoption. Achieving an optimal balance of properties in aluminum-based composites for advanced applications remains a significant challenge that requires further development and efforts. By addressing these challenges, the industrial viability and potential applications of aluminum-based composites can be enhanced.

In view of the foregoing, it is one objective of the present disclosure to develop an aluminum-based composite that overcomes the limitations of the art. A second objective of the present disclosure is to describe a method of making an aluminum-cubic boron nitride (Al-cBN) composite. A third objective of the present disclosure is to describe a light weight material containing the Al-cBN composite.

### SUMMARY

In an exemplary embodiment, a method of making an aluminum-cubic boron nitride (Al-cBN) composite is described. The method includes mixing an aluminum powder and particles of cubic boron nitride (cBN) in a solvent and sonicating to form an Al-cBN mixture. The method further includes drying the Al-cBN mixture to form a dried mixture powder, and sintering by pressing and heating the dried mixture powder to form the Al-cBN composite in the form of a disc. In some embodiments, the aluminum powder has an average particle size of 10 to 100 micrometers (μm). In some embodiments, the cBN particles have an average particle size of from 10 to 100 m, and are uniformly dispersed throughout the Al-cBN composite.

In some embodiments, the aluminum powder has an average particle size of about 50 μm.

In some embodiments, the cBN particles have a cubic or octahedral shape and an average particle size of from 20 to 60 μm.

In some embodiments, the Al-cBN composite prepared by the method of the present disclosure has a network matrix of aluminum. In some embodiments, the cBN particles are uniformly dispersed throughout the network matrix of aluminum.

In some embodiments, the solvent is at least one alcohol selected from the group consisting of methanol, ethanol and propanol.

In some embodiments, a weight ratio of the aluminum powder to the cBN particles is in a range of from 100:1 to 5:1.

In an exemplary embodiment, the pressing is performed under a uniaxial pressure in a range of 30 to 70 megaPascals (MPa).

In some embodiments, the heating is performed at a temperature in a range of 500 to 600° C.

In some embodiments, during the sintering, the aluminum powder and the cBN particles in the dried mixture do not react.

In some embodiments, the Al-cBN composite has an average hardness in a range of 1 to 2 gigaPascals (GPa).

In some embodiments, the Al-cBN composite has an average elastic modulus in a range of 70 to 80 GPa.

In some embodiments, the Al-cBN composite has a density in a range of 2.5 to 2.7 grams per cubic centimeter (g/cm³).

In some embodiments, the Al-cBN composite has a densification in a range of 94 to 99% based on a density of the aluminum powder.

In an exemplary embodiment, a light weight material comprising the Al-cBN composite prepared by the method of present disclosure is described. A weight ratio of the aluminum powder to the cBN particles is about 9:1, and the cBN particles have an average particle size of from 20 to 60 μm.

In some embodiments, the light weight material has a density in a range of 2.55 to 2.65 g/cm³.

In some embodiments, the light weight material is at least part of a cutting tool, an abrasive tool, mold, die, break-ring, nozzle, glass forming tool, metal forming refractory tool, high temperature refractory shape, furnace vent, furnace stack, furnace fixture, generator component, reactor component, turbine component, engine component, vehicular component, aerospace component, ship, submarine component, aircraft component, weapon, or armor.

In some embodiments, the light weight material when exposed to a salt solution has a corrosion rate in a range of from 4 to 35 mils per year (mpy).

In some embodiments, the salt solution contains at least one salt selected from the group consisting of sodium chloride, potassium chloride, magnesium chloride, magnesium sulfate, calcium sulfate, calcium carbonate, and sodium bicarbonate.

In some embodiments, the salt is present in the salt solution at a concentration of 1 to 8% by weight.

In some embodiments, the light weight material has a corrosion current density (i_{corr}) of 3 to 30 microamperes square centimeters (μA cm²) under a potential of −1.0 to 0 V (vs Ag/AgCl).

The foregoing general description of the illustrative present disclosure and the following The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method of making an aluminum-cubic boron nitride (Al-cBN) composite, according to certain embodiments;

FIG. 1B is a schematic illustration of a spark plasma sintering (SPS) process and the die setup including graphite materials, according to certain embodiments;

FIG. 2A shows a field emission scanning electron microscope (FESEM) micrograph of pristine Al powder, according to certain embodiments;

FIG. 2B shows a FESEM micrograph of cubic boron nitride (cBN) particles in powder form, according to certain embodiments;

FIG. 2C shows energy-dispersive X-ray spectroscopy (EDX) spectrum of a composite powder of Al and cBN particles (Al-cBN composite), in powder form, according to certain embodiments;

FIG. 3A shows a FESEM micrograph of the Al-cBN composite with 20 μm cBN particles, according to certain embodiments;

FIG. 3B shows a FESEM micrograph of the Al-cBN composite with 40 m cBN particles, according to certain embodiments;

FIG. 3C shows a FESEM micrograph of the Al-cBN composite with 60 m cBN particles, according to certain embodiments;

FIG. 4A shows X-ray diffraction pattern (XRD) of pristine Al powder and cBN particles (in powder form), according to certain embodiments;

FIG. 4B shows XRD patterns of Al-cBN composites with 20, 40, and 60 μm cBN particles, according to certain embodiments;

FIG. 5A and FIG. 5D show FESEM micrographs of Al-cBN composite with 20 μm cBN particles mixed with Al powder under different magnifications, according to certain embodiments;

FIG. 5B and FIG. 5E show FESEM micrographs of Al-cBN composite with 40 μm cBN particles mixed with Al powder under different magnifications, according to certain embodiments;

FIG. 5C and FIG. 5F show FESEM micrographs of Al-cBN composite with 60 μm cBN particles mixed with Al powder under different magnifications, according to certain embodiments;

FIG. 6A is a plot of hardness and elastic modulus as a function of reinforcement size, according to certain embodiments;

FIG. 6B is a plot of load vs. depth as a function of reinforcement size, according to certain embodiments;

FIG. 7 shows open circuit potential (OCP) curves for pure Al and its cBN-based composites in a 3.5 wt. % NaCl solution, according to certain embodiments;

FIG. 8A shows galvanic interactions between cBN and Al in Al-cBN composite with 20 m cBN particles, according to certain embodiments;

FIG. 8B shows galvanic interactions between cBN and Al in Al-cBN composite with 40 m cBN particles, according to certain embodiments;

FIG. 8C shows galvanic interactions between cBN and Al in Al-cBN composite with 60 m cBN particles, according to certain embodiments;

FIG. 9A is a Nyquist plot of pristine Al and its cBN-based composites in 3.5 wt. % NaCl solution obtained with measurement for 1 h, according to certain embodiments;

FIG. 9B shows an equivalent circuit of pristine Al and its cBN-based composites in 3.5 wt. % NaCl solution obtained with measurement for 1 h, according to certain embodiments;

FIG. 10A is a Bode magnitude plot of pristine Al and its cBN-based composites in 3.5 wt. % NaCl solution obtained with measurement for 1 h, according to certain embodiments;

FIG. 10B is a Bode phase plot of pristine Al and its cBN-based composites in 3.5 wt. % NaCl solution obtained with measurement for 1 h, according to certain embodiments;

FIG. 11A shows cyclic polarization curves of pristine Al in 3.5 wt. % NaCl solution, according to certain embodiments;

FIG. 11B shows cyclic polarization curves of Al-cBN composite with 20 m cBN particles, in 3.5 wt. % NaCl solution, according to certain embodiments;

FIG. 11C shows cyclic polarization curves of Al-cBN composite with 40 m cBN particles, in 3.5 wt. % NaCl solution, according to certain embodiments;

FIG. 11D shows cyclic polarization curves of Al-cBN composite with 60 m cBN particles, in 3.5 wt. % NaCl solution, according to certain embodiments; and

FIG. 12 shows Eₚᵢₜ and E_{corr} values for pristine Al and its cBN-based composites in a 3.5 wt. % NaCl solution, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to aluminum-cubic boron nitride (Al-cBN) composites with different reinforcement sizes made by via spark plasma sintering (SPS) while maintaining a constant weight percentage. The mechanical and electrochemical properties of the composites were investigated as a function of the cBN particle size.

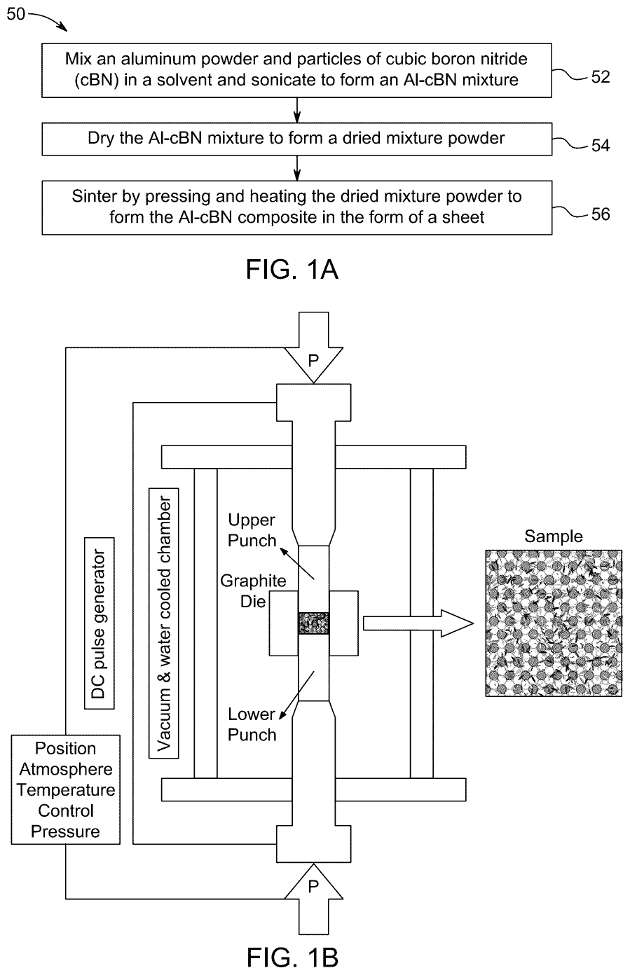

FIG. 1 illustrates a flow chart of a method 50 of making an aluminum-cubic boron nitride composite (Al-cBN). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

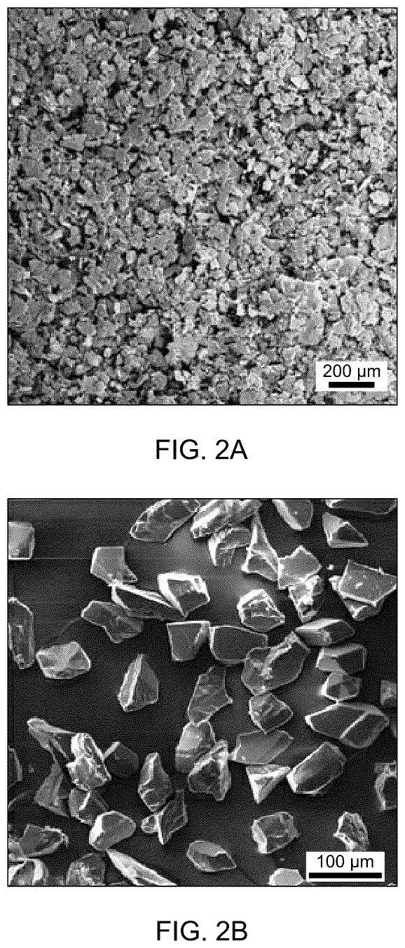

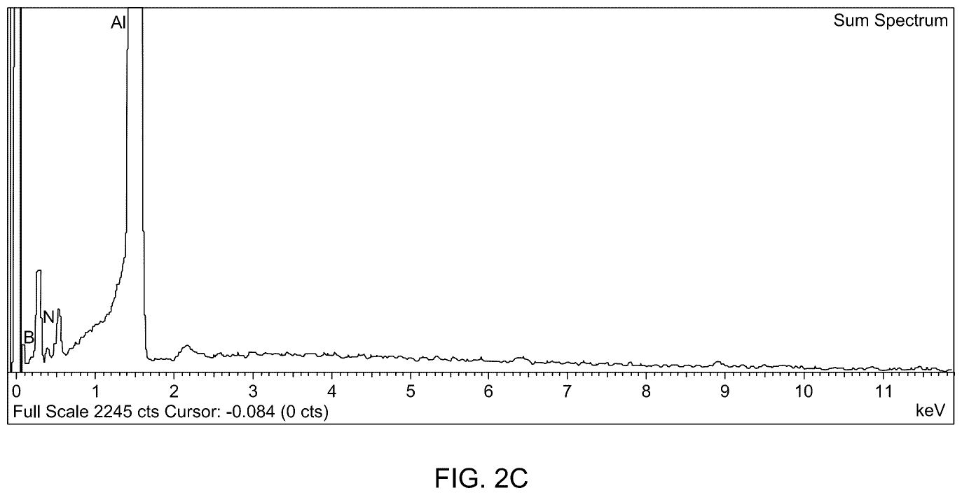

At step 52, the method 50 includes mixing an aluminum powder and particles of cubic boron nitride (cBN) in a solvent and sonicating to form an Al-cBN mixture. In some embodiments, the aluminum powder has an average particle size of 10 to 100 micrometers (μm), preferably 20-80, preferably 30-60, preferably 40-50, preferably 50 m, as depicted in FIG. 2A. Other ranges are also possible. The cBN may be in crystalline form. The cBN has physical and chemical properties, such as a high hardness, wide bandgap, high thermal conductivity, high electrical resistivity, chemical inertness, etc. In some embodiments, other forms of boron nitride, such as amorphous form, hexagonal form, wurtzite form, and combinations thereof, may be present in the particles of the cubic boron nitride, with the major component being the boron nitride in the cubic phase. The cBN particles have an average particle size of 10 to 100 m, preferably 20-80, preferably 20 to 60 m, as depicted in FIG. 2B. Other ranges are also possible. In some embodiments, the aluminum powder and the particles of cBN are mixed in a solvent to form the Al-cBN mixture in which Al particles and cBN particles are suspended. The solvent is preferably at least one alcohol selected from the group consisting of methanol, ethanol, and propanol. In some embodiments, the solvent is ethanol. In some embodiments, a weight ratio of the aluminum powder to the cBN particles is in a range of from 100:1 to 5:1, preferably 90:1 to 5:1, preferably 80:1 to 5:1, preferably 70:1 to 5:1, preferably 60:1 to 5:1, preferably 50:1 to 5:1, preferably 40:1 to 5:1, preferably 30:1 to 5:1, preferably 20:1 to 5:1, preferably 10:1 to 5:1, preferably 9:1. Other ranges are also possible. The Al-cBN mixture was sonicated for complete dispersion of the aluminum powder and the particles of cBN in the solvent. The sonication process results in impacting aluminum powder and the particles of cBN in the solvent resulting in intimate contact between them. In an embodiment, the sonication may be carried out using a sonication probe or in an ultrasonic bath.

Boron nitride occurs in a variety of forms, including as amorphous boron nitride, cubic boron nitride (cBN), hexagonal boron nitride (hBN), or as rhombohedral (rBN) or Wurtzeit (wBN) boron nitride allotropes. Boron nitride may also be in the form of nanotubes of substantially pure boron nitride. In the present disclosure, the boron nitride generally contains at least 90 wt. % cBN, preferably at least 95 wt. % cBN, preferably at least 99 wt. % cBN, or even more preferably at least 99.9 wt. % cBN. Other ranges are also possible.

At step 54, the method 50 includes drying the Al-cBN mixture to form a dried mixture powder. The Al-cBN mixture was dried to a temperature range of 60-100° C., preferably 70-90° C., preferably 80° C. for at least 4 hours, preferably at least 8 hours, preferably at least 12 hours, preferably at least 16 hours, preferably at least 20 hours, or even more preferably at least 24 hours, to allow for the evaporation of the solvent. Other ranges are also possible. In some embodiments, the temperature may be determined based on the choice of the solvent. The drying can be done by using heating appliances such as ovens, microwaves, autoclaves, hot plates, heating mantles and tapes, oil baths, salt baths, sand baths, air baths, hot-tube furnaces, and hot-air guns.

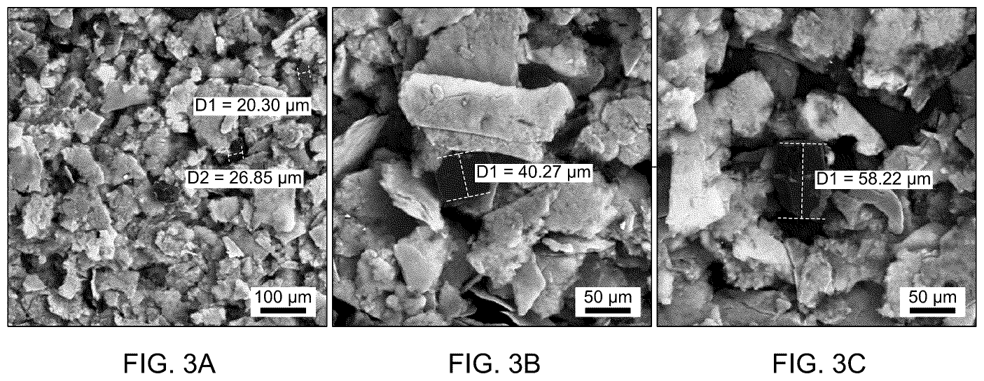

Referring to FIGS. 3A to 3B, the cBN particles are uniformly distributed throughout the dried mixture powder and are preferably uniformly dispersed in the aluminum particles. In some embodiments, the cBN particles are in cubic or octahedral shapes having an average particle size of from 20 to 60 m, or even more preferably about 30 to 50 μm. Other ranges are also possible. Furthermore, the aluminum powder and the cBN particles in the dried mixture do not react before the sintering. In some more preferred embodiments, the dried mixture is optionally further mixed using a mortar and pestle to provide a substantially uniform distribution of cBN particles in the aluminum particles.

At step 56, the method 50 includes sintering by pressing and heating the dried mixture powder to form the Al-cBN composite in the form of a disc. Sintering, which is also called “frittage,” is the process of forming a solid mass of material through heat and pressure without melting to the point of liquefaction. During the sintering process, the aluminum powder, and particles of cBN to fuse together to form a homogeneous material in which the cBN particles are dispersed in a matrix of the Al particles, with no chemical reaction taking place between the aluminum powder and the cBN particles. The sintering cycle is dependent on the geometry and the dimension aspect ratio of the pressed shape. Because of the possible hazards of reaction or ignition during sintering, sintering is performed under an inert media, for example, an argon atmosphere, to prevent any oxidation or surface reaction. It involves two stages—pressing the dried mixture followed by heating to form the Al-cBN composite.

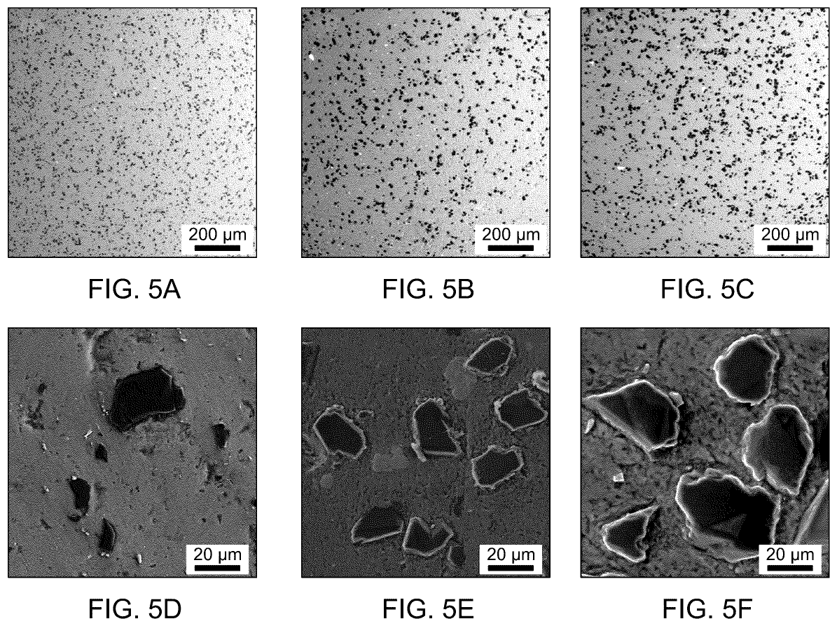

During pressing, the dried mixture is pressed in a die, preferably a graphite die, to make a specific shape. The graphite die has a thickness of 10-30 mm, preferably 15-25 mm, preferably 20 mm. Other ranges are also possible. A uniaxial force was applied to the dried mixture in a range of 30 to 70 megaPascals (MPa), preferably 40-60 MPa, preferably 50 MPa. A holding time of 10-20 minutes, preferably 10 minutes, is sufficient, depending on the amount of dried mixture. Other ranges are also possible. The pressed sample is further heated at a rate of about 50-120° C./minute, preferably 60-100° C./minute, preferably 100° C./minute, to a final temperature in the range of 500-600° C., preferably 550° C., holding at the final temperature for 10-20 minutes, preferably 10 minutes, and then cooling to room temperature, to form the Al-cBN composite, where the cBN particles are uniformly dispersed throughout the Al-cBN composite. Other ranges are also possible. The Al-cBN composite thus obtained is in the form of a disk having the specific shape of the graphite die. In some embodiments, the disk of the Al-cBN composite has a thickness of 0.1 to 10 mm, preferably 0.15 to 5 mm, preferably 0.2 to 1 mm, or even more preferably about 0.35 mm, as depicted in FIGS. 5A to 5F. Other ranges are also possible.

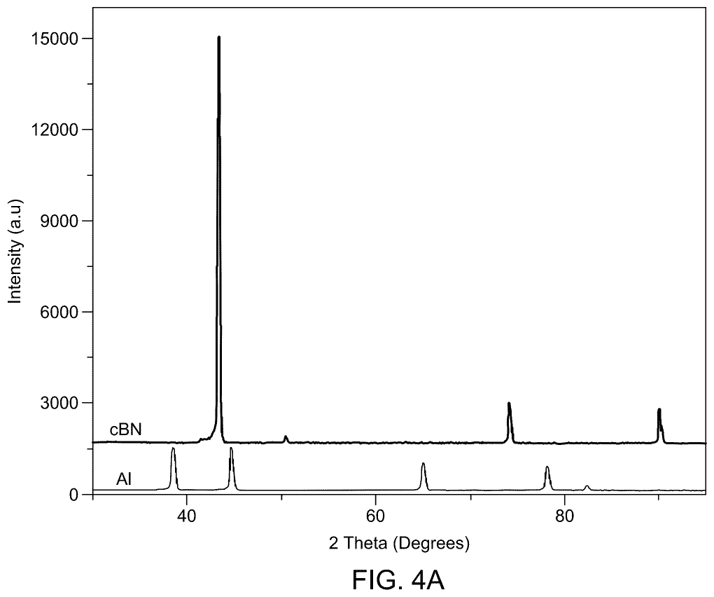

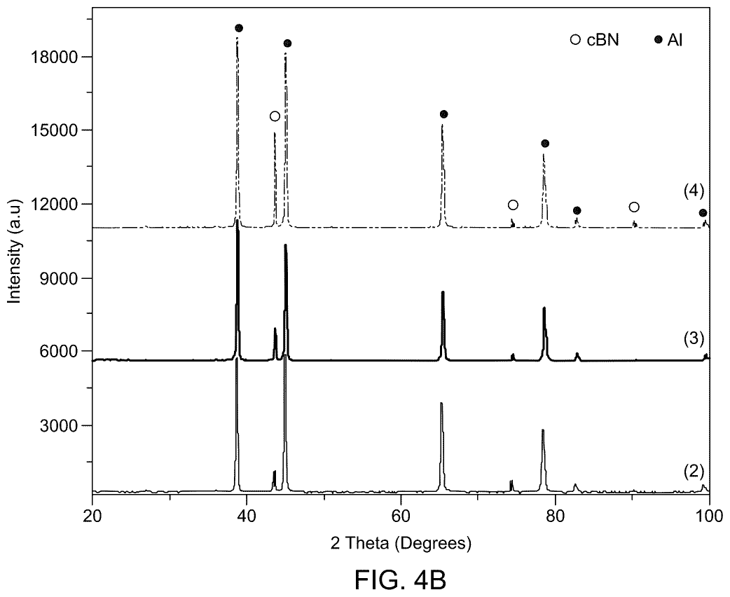

The crystalline structures of the Al-cBN composite may be characterized by X-ray diffraction (XRD). The XRD patterns are collected in a Rigaku MiniFlex diffractometer equipped with a Cu-Kα radiation source (λ=0.15416 nm) for a 20 range extending between 5 and 100°, preferably 15 and 80°, further preferably 30 and 60° at an angular rate of 0.005 to 0.04° s⁻¹, preferably 0.01 to 0.03° s⁻¹, or even preferably 0.02° s⁻¹. In some embodiments, the Al-cBN composite has at least a first intense peak with a 2 theta (0) value in a range of 37 to 40°, preferably about 38.7°, as depicted in FIG. 4B. In some further embodiments, the Al-cBN composite has at least a second intense peak with a 20 value in a range of 41 to 50°, preferably about 42 to 46°, as depicted in FIG. 4B. In some further embodiments, the Al-cBN composite has at least a third intense peak with a 20 value in a range of 63 to 68°, preferably about 65°, as depicted in FIG. 4B. In some further embodiments, the Al-cBN composite has at least a fourth intense peak with a 20 value in a range of 75 to 80°, preferably about 78°, as depicted in FIG. 4B. Other ranges are also possible.

Also referring to FIG. 4B, XRD did not show any phase transformation from cBN to hBN (hexagonal BN), which is attributed to the sintering parameters (temperature, pressure, and time) that are not suitable for transitioning cBN to hBN, resulting in improved physical, chemical, thermal, and mechanical properties of the Al-cBN composites. This phase transition may be inhibited or prevented by the selection of microsized Al particles, the cBN particles and by use of which, in some embodiments, is in turn is attributable to the pulse-based, faster and efficient heating provided by selection of spark plasma sintering. These factors may help in consolidating the resulting Al-cBN composite in a short period of time that is not long enough for substantial transformation of cBN to hBN to occur.

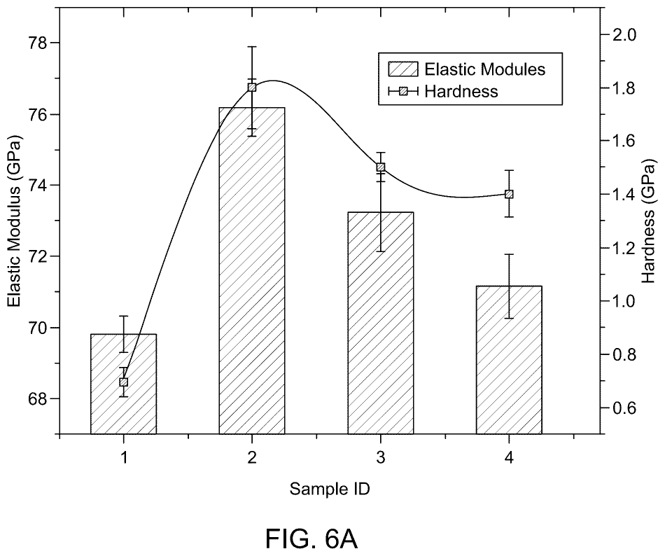

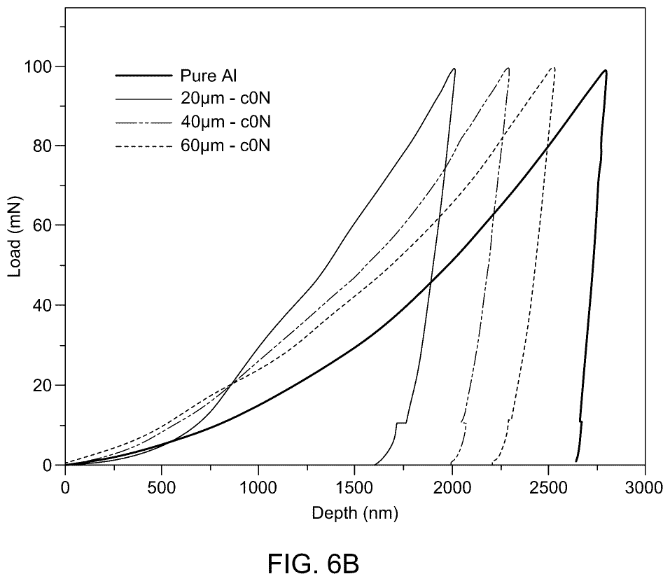

Referring to FIG. 6A, the Al-cBN composite has an average hardness in a range of 1 to 2 gigaPascals (GPa), preferably 1.2 to 1.8 GPa, preferably 1.4 to 1.6 GPa, or even more preferably about 1.5 GPa. Other ranges are also possible. In some embodiments, the hardness may be determined according to ASTM E384 Knoop and Vickers Hardness Testing, which is incorporated herein by reference in its entirety.

In some embodiments, the Al-cBN composite has an average elastic modulus in a range of 70 to 80 GPa, preferably 72 to 78 GPa, preferably 74 to 76 GPa, or even more preferably about 75 GPa, as depicted in FIG. 6A. Other ranges are also possible

In some preferred embodiments, the Al-cBN composite has a density in a range of 2.5 to 2.7 grams per cubic centimeter (g/cm³), preferably 2.55 to 2.65 g/cm³, or even more preferably about 2.6 g/cm³. In some more preferred embodiments, the Al-cBN composite has a densification in a range of 94 to 99% based on a density of the aluminum powder, preferably 95 to 98%, or even more preferably 96 to 97% based on the density of the aluminum powder. Other ranges are also possible.

Electrochemical characterization may be performed using an electrochemical cell equipped with a three-electrode configuration. In some embodiments, graphite was used as the counter electrode, and a Ag/AgCl (sat. KCl) electrode was employed as a reference coupled with a potentiostat (1000E, Gamry, USA). In some embodiments, the Al-cBN composite may be used as the working electrode. The electrochemical analysis may be performed in a NaCl electrolyte having a concentration of 1 to 5 wt. %, or even more preferably about 3.5 wt. % by weight at room temperature (25±1° C.). The open-circuit potential (OCP) analysis may be performed for 0.5 to 3 hours, or even more preferably about 1 hour. Electrochemical impedance spectroscopy (EIS) tests may be performed at the corrosion potential (EOCP) and a frequency range of 100 kHz to 0.01 Hz with a potential perturbation of 1 to 10 mV (rms), or even more preferably about 5 mV (rms) at 0 V vs. OCP. In some embodiments, the cyclic potentiodynamic polarization (CPP) analysis may be scanned from −0.3 to +1.5 V against OCP at the scan rate of 1 to 10 mV/s, or even more preferably about 2.5 mV/s. Other ranges are also possible.

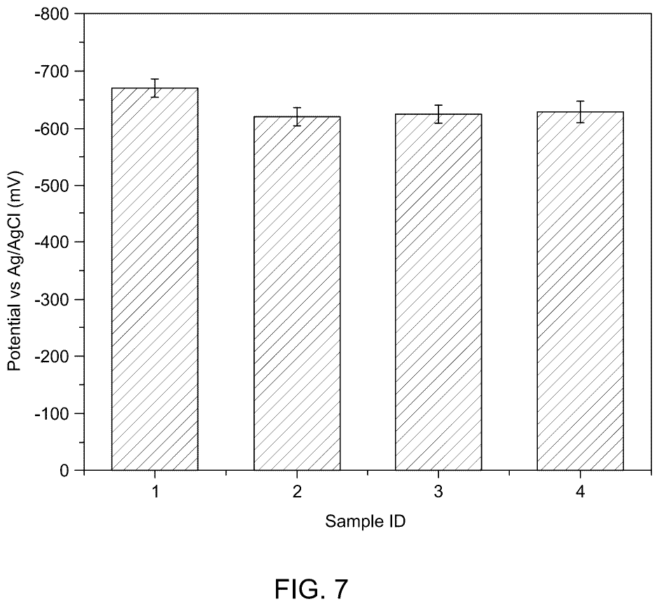

Referring to FIG. 7, the Al-cBN composite has a potential of −800 to −400 mV (vs Ag/AgCl), preferably −700 to −500 mV, preferably −650 to −500 mV, or even more preferably −630 to −550 mV. Other ranges are also possible.

Referring to FIG. 1B, a spark plasma sintering (SPS) process and the die setup [Saheb, N., et al., Spark plasma sintering of metals and metal matrix nanocomposites: a review. Journal of Nanomaterials, 2012, which is incorporated herein by reference in its entirety]. The term “spark plasma sintering,” or “SPS”, generally refers to a process whereby a material in the form of a powder is subjected to heat by applying high direct current in combination with uniaxial pressure. It can result in particles bonding together to form a coherent body with reduced porosity, increased density and improved hardness, toughness and strength. In some embodiments, the spark plasma sintering apparatus of the present embodiment includes a DC pulse generator, a control panel, and a sintering furnace. The sintering furnace includes an upper electrode, an upper punch, a thermocouple, a working chamber containing a die, a lower punch, a vacuum chamber, and a lower electrode. The upper electrode and the lower electrode are operatively configured to the DC pulse generator for generating a pulse current. Additionally, the DC pulse generator is operatively configured to the control panel for controlling and monitoring the position of the upper punch and lower punch, as well as the atmosphere, temperature and pressure of the sintering furnace. In some embodiments, the sintering furnace is for applying pressure to a working chamber and the die for holding a raw material inserted into the working chamber. During the spark plasma sintering, a dried mixture powder placed on the die in a working chamber and is compressed by applying pressure between the upper punch and lower punch, and a pulse current is applied between the upper punch and lower punch. In some embodiments, the die may be made of graphite. In some further embodiments, a graphite sheet is inserted between the graphite die and the dried mixture powder to facilitate the removal of the sample after sintering from the die and avoid the wear of the punches. The dried mixture power may be prepared by grinding and polishing before sintering. The grinding may be performed on a diamond wheels having grit sizes in a range of 5 to 100 μm, preferably 10 to 80 μm, or even more preferably 20 to 60 μm. In some preferred embodiments, the polishing may be performed using alumina suspension having an average particle size of 50 to 500 nm, preferably 100 to 300 nm, or even more preferably about 200 nm, to attain a 0.1 to 1 μm, preferably about 0.25 μm surface finish. Other ranges are also possible.

A light weight material, including the Al-cBN composite, prepared by the method of the present disclosure, is described. As used herein, the term “lightweight material”, generally refers to a type of material that exhibits low density or weight relative to its volume or size. In the present disclosure, the light weight material has a density in the range of 2.55 to 2.65 g/cm³, preferably 2.57 to 2.63 g/cm³, or even more preferably 2.59 to 2.61 g/cm³. Other ranges are also possible. Suitable examples of the light weight material is at least part of a cutting tool, an abrasive tool, mold, die, break-ring, nozzle, glass forming tool, metal forming refractory tool, high temperature refractory shape, furnace vent, furnace stack, furnace fixture, generator component, reactor component, turbine component, engine component, vehicular component, aerospace component, ship, submarine component, aircraft component, weapon, or armor. In an embodiment, the Al-cBN composite of the invention may be used to form a material such as a durable solid material, granule or powder. As a powder or granule (e.g. having grains ranging from 0.001 to 2 mm in average size (TEM) it may be incorporated into or onto an abrasive surface such as a surface or into a gaseous, liquid or solid composition for grinding, polishing, buffing, honing, cutting, drilling, sharpening, lapping, or sanding.

In the light weight material, the cubic boron nitride is crystalline. In some embodiments, other forms of boron nitride, such as amorphous form, hexagonal form, wurtzite form, and combinations thereof, may be present in the particles of the cubic boron nitride, with the major component being the boron nitride in the cubic phase. The cBN particles have an average particle size of 10 to 100 m, preferably 20-80, preferably 20 to 60 μm. The weight ratio of the aluminum powder to the cBN particles is in a range of from 100:1 to 5:1, preferably 90:1 to 5:1, preferably 80:1 to 5:1, preferably 70:1 to 5:1, preferably 60:1 to 5:1, preferably 50:1 to 5:1, preferably 40:1 to 5:1, preferably 30:1 to 5:1, preferably 20:1 to 5:1, preferably 10:1 to 5:1, preferably 9:1. The weight ratio of the aluminum powder to the cBN particles is about 9:1. Other ranges are also possible.

The light weight material including Al-cBN composite shows an increased resistance to corrosion. For example, the light weight material, including the Al-cBN composite, when exposed to a salt solution has a corrosion rate in a range of from 4 to 35 mils per year (mpy). The salt solution includes at least one salt selected from the group consisting of sodium chloride, potassium chloride, magnesium chloride, magnesium sulfate, calcium sulfate, calcium carbonate, and sodium bicarbonate. In an embodiment, the salt is present in the salt solution at a concentration of 1 to 8% by weight. The light weight material has a corrosion current density (icₒᵣᵣ) of 3 to 30 microamperes square centimeters (μA cm²), preferably 8 to 25 pA cm², preferably 13 to 20 pA cm², or even more preferably about 17 pA cm², under a potential of −1.0 to 0 V (vs Ag/AgCl). Other ranges are also possible.

A physical property of the light weight of the invention, including a mechanical, chemical or thermal property, may vary upward or downward by at least 1, 2, 3, 4, 5, 10, 15, 20, 25, 30, 35, 40, 45, 50, 55, 60, 65, 70, 75, 80, 85, 90, 95 100% or more (or any intermediate value within this range) compared to an otherwise similar aluminum composite made without the cBN particles, or to an otherwise similar composite that is conventionally sintered not using SPS.

The composite of the present invention with a cBN particle size of, e.g., 20 μm strengthens the matrix owing to the better stress drive in the matrix and exhibits the improved average hardness (1.78 GPa), elastic modulus (76.1 GPa), and percentage of densification (98.1%).

As used herein, the term “stress drive,” or “stress distribution” generally refers to how stress is distributed or spread throughout a material under external loads or forces. In the present disclosure, the term “stress drive” may be determined by numerical simulations, e.g., finite element analysis; by experimental methods, e.g., strain gauges and/or stress-sensitive materials; and by any other suitable method known to those of skill in the art.

The corrosion behavior and resistance against pitting corrosion of pure Al and cBN-based composites were investigated in a 3.5 wt. % NaCl solution using electrochemical techniques, such as open circuit potential, electrochemical impedance spectroscopy, and cyclic potentiodynamic polarization analyses. Electrochemical studies revealed that among the analyzed samples, the composite with 20 m cBN particles exhibits an improved polarization resistance in addition to the lowest corrosion rate (4.533 mills per year) and a high resistance to pit formation in a corrosive environment.

### EXAMPLES

The following examples demonstrate a method of making an aluminum-cubic boron nitride composite (Al-cBN) as described herein. The examples are provided solely for illustration and are not to be construed as limitations of the present disclosure, as many variations thereof are possible without departing from the spirit and scope of the present disclosure.

### Example 1: Materials

Pure Alfine powder (average particle size ˜50 m), 93% complexometric; CAS: 7429-90-5, Sigma-Aldrich) was used as a matrix for preparing the composites. cBN with average particle sizes of 20, 40, and 60 μm (Element Six, ABN800, USA) was used as a reinforcement. The weights of the compositions of each sample are listed in Table 1.

TABLE 1
Compositions of aluminum-cBN samples in grams (g). Pure aluminum,
sample 1, and composites from Sample 2-4 with cBN
particle size 20, 40, and 60 μm, respectively

| Sample | | Composition (g) | |
|---|---|---|---|
| ID | cBN size in Al matrix (μm) | Al | CBN |
| 1 | 0 | 9 | 0 |
| 2 | 20 | 8.1 | 0.9 |
| 3 | 40 | 8.1 | 0.9 |
| 4 | 60 | 8.1 | 0.9 |

The samples were homogenized using an ultrasonic probe sonicator (Model VC 750, Sonics, 300 Johnny Bench Dr., Oklahoma City, OK, 73104, USA), using ethanol as the mixing medium. Next, ethanol was evaporated by heating the samples in an oven at 80° C. for 24 h. Finally, the powder mixtures were consolidated using the SPS apparatus (FCT System, HP D5, Germany), as depicted in FIG. 1B. The powder mixture was placed in a 20 mm graphite die, pressed at 50 MPa, and heated at a rate of 100° C./min. All the samples were sintered at 550° C., and the holding time was 10 min.

To facilitate the removal of the sample from the die and avoid the wear of the punches, a graphite sheet (thickness: 0.35 mm) was inserted between the graphite die and the powders. Additionally, the die was covered with a graphite blanket during sintering to minimize heat loss. The sintering temperature was measured using a pyrometer placed near the sample. To remove the graphite sheet and obtain a clean surface, the sintered samples were first ground using 60-grit SiC paper, followed by grinding on a diamond disk. The samples were ground and polished using an AutoMet 300 Buehler grinding machine for mechanical and microstructural investigations. Grinding was performed using diamond wheels with grit sizes ranging from 74 to 10 μm. Subsequently, the samples were polished using alumina (200 nm) suspension to attain a 0.25 μm surface finish. Following SPS and grinding, the densities of the sintered samples were measured via Archimedes' method using density determination equipment (Mettler Toledo), with deionized water as the immersion medium. A nanoindenter (iMicro, Nanomechanics, Oak Ridge, TN, USA) with a three-sided Berkovich tip was used to measure the hardness and elastic modulus. A maximum load of 100 mN was applied during the nanoindentation tests. The reported density, hardness, and elastic modulus values are the average of nine measurement values. To identify the phases, present in the sintered samples, a Rigaku MiniFlex X-ray diffractometer (manufactured by Rigaku, 3 Chome-9-12 Matsubaracho, Akishima, Tokyo 196-8666, Japan) was used with Cu K_{α1} radiation (γ=0.15416 nm); it was operated at a tube current of 10 mA and an accelerating voltage of 30 kV. A field-emission scanning electron microscopy (FESEM) system (Lyra3, manufactured by Tescan Brno, Czech Republic) equipped with energy-dispersive X-ray spectroscopy (EDX) silicon drift detector (X-MaxN, Oxford Instruments, Tubney Wood, Abingdon, Oxfordshire, OX13 5QX, United Kingdom) operated at an accelerating voltage of 20 kV was used to characterize the microstructures of the sintered samples and powders. Electrochemical characterization was performed using an electrochemical cell with a three-electrode configuration. Herein, graphite was used as the counter electrode, and Ag/AgCl (sat. KCl) electrode was employed as a reference coupled with a potentiostat (1000E, Gamry, 734 Louis Dr, Warminster, Pennsylvania, 18974, United States). Pure Al and Al-cBN composite electrodes were used as the working electrodes. Each specimen was prepared for electrochemical measurements by soldering a copper wire to one end and then cold-mounted in resin. The samples were dried in the open air for 24 h at room temperature (25±1° C.). Before executing the test, the exposed area was ground using P1000 grit emery paper. The electrode was cleaned with deionized water and dried in dry air. The exposed surface area of each specimen was 1.12 cm². Electrochemical analysis was performed in a 3.5 wt. % NaCl electrolyte at room temperature (25±1° C.). The open-circuit potential (OCP) analysis was performed for 1 h. Electrochemical impedance spectroscopy (EIS) tests were performed at the corrosion potential (EOCP) and a frequency range of 100 kHz to 0.01 Hz with a potential perturbation of 5 mV (rms) at 0 V vs. OCP. For cyclic potentiodynamic polarization (CPP) analysis, the potential was first forward scanned from −0.3 to +1.5 V against OCP at the scan rate of 2.5 mV/s. After that, the potential was reversed in the opposite direction from +1.5 to −0.3 V for the back scan at the same scan rate to complete the test.

### Example 2: FESEM Analysis

FIG. 2A and FIG. 2B show the FESEM micrographs of powders of Al and cBN particles, respectively—the Al particles, as depicted in FIG. 2A possesses an average particle size of 50 m, as measured using the Image J software. The EDX spectrum of the composite powders of Al and cBN particles (also referred to as Al-cBN composite) in powder form is depicted in FIG. 2C. The FESEM micrographs of the Al-cBN composite are depicted in FIG. 3A-FIG. 3C. The size of the cBN particles in the Al-cBN composite is 20, 40, and 60 μm, respectively, as observed in FIG. 3A-FIG. 3C.

### Example 3: XRD Analysis

The X-ray diffraction (XRD) patterns of pure Al and cBN powders, as depicted in FIG. 4A reveals the crystalline nature of Al and cBN. FIG. 4B shows the XRD patterns of consolidated compositions, i.e., Al-cBN composites with 20 (2), 40 (3), and 60 (4) μm cBN particles. The Al-cBN composites were obtained after sintering at 550° C., at a pressure of 50 MPa for 10 minutes. The XRD patterns indicate that no chemical reaction occurred between Al and cBN at 550° C. In ceramic-metal composites, the reaction generally occurs at the first few atomic layers of the interface and is undetectable using XRD [Yan, Q., et al., A microstructure study of Ni/Al₂O₃ composite ceramics. Journal of Alloys and Compounds, 2009. 467(1-2): p. 438-443, which is incorporated herein by reference in its entirety]. Additionally, XRD and Raman analyses did not indicate any phase transformation from cBN to hBN (hexagonal BN), suggesting that the sintering parameters (temperature, pressure, and time) are unsuitable for transitioning cBN to hBN [Irshad, H. M., et al., Investigation of the structural and mechanical properties of micro-/nano-sized Al₂O₃ and cBN composites prepared by spark plasma sintering. ceramics international, 2017. 43(14): p. 10645-10653, which is incorporated herein by reference in its entirety]. As the reinforcement size increases from 20 to 60 μm, the diffraction peak intensity corresponding to cBN clearly increases (FIG. 4B), indicating that more planes are available for the Bragg diffractions. Three distinct XRD peaks are observed at 20 values of approximately 43.2°, 74.4°, and 90.1°.

Referring to FIG. 5A-FIG. 5F, the FESEM images show that the cBN particles are well dispersed in the metallic matrix. However, pores are observed in the polished surfaces of the compositions, whereas they are not detected in the samples with small-sized reinforcements. This difference may be due to the variations in the bonding strength at the interface as a function of the particle size (both the metal matrix and cBN). The composite with 20 μm cBN particles (FIGS. 5A and 5D) is well consolidated and exhibits a fine microstructure, owing to the small, reinforced particles and their uniform dispersion in the metallic matrix. As a result of the reduction in the reinforcement size, particles remain intact and firmly within the matrix. They are densely and utterly covered with the Al matrix, compared to the composite with 40 μm cBN particles (FIG. 5B and FIG. 5E) and 60 μm cBN particles (FIG. 5C and FIG. 5F). The composite exhibits an improved microstructure with filled pores, which enhanced the bonding of the particles with the matrix at the interface, thereby improving the mechanical and electrochemical properties. In ceramic-reinforced composites, the metallic phase can significantly improve the ambient temperature properties by refining the microstructure pores and interfacial bonding strength [Yin, Z., et al., Effects of particulate metallic phase on microstructure and mechanical properties of carbide reinforced alumina ceramic tool materials. Ceramics International, 2014. 40(2): p. 2809-2817, which is incorporated herein by reference in its entirety]. These results shows that small cBN particles (20 m) were well distributed and intact in the metallic matrix due to probe sonication, drying, mixing using a mortar and pestle, and sintering.

### Example 4: Densification, Mechanical, and Electrochemical Properties

The densification of the Al-cBN composite decreased as the reinforcement size increased due to the difference in consolidation and the presence of voids at the interface. Composites with finer particles have a relatively well-consolidated and denser microstructure, owing to the fine voids and the excess number of particles in the metallic matrix (maintaining a constant weight or volume percent of reinforcement). This result agrees with the FESEM micrographs (as depicted in FIG. 5), which show fewer voids, finer grains, and better-packed inclusions in the Al matrix for smaller-sized cBN particles. A similar trend is observed for the elastic modulus and hardness, as shown in FIG. 6A and FIG. 6B, which are in agreement with the findings above.

The hardness and elastic modulus increased with the addition of increased number of particles (i.e., finer reinforcement), imparting the strengthening effect to the metallic matrix. According to FIG. 6A, fine reinforced particles provide better resistance to localized deformation of the matrix, causing an increase in the dislocation pile-up at the particles, as the particulate content is increased in the Al matrix, which improves the overall strength of the matrix by restraining the grain size. This may be because hard dispersoids plastically constrain the metallic matrix [Bhushan, R. K., Effect of SiC particle size and weight % on mechanical properties of AA7075 SiC composite. Advanced Composites and Hybrid Materials, 2021. 4(1): p. 74-85; Canakci, A., S. Ozsahin, and T. Varol, Prediction of effect of reinforcement size and volume fraction on the abrasive wear behavior of AA2014/B4Cp MMCs using artificial neural network. Arabian Journal for Science and Engineering, 2014. 39(8): p. 6351-6361; and Humphreys, F., The thermomechanical processing of Al—SiC particulate composites. Materials Science and Engineering: A, 1991. 135: p. 267-273, each of which is incorporated herein by reference in its entirety]. The presence of a larger number of hard particles (in the case of finer reinforcement) restricts the plastic flow of the matrix because of the uniform distribution and better stress drive of the particulates (stress distribution) in the bulk volume of the composite. The stress drive and strength depend on the size and particle spacing of MMCs [El-Kady, O. and A. Fathy, Effect of SiC particle size on the physical and mechanical properties of extruded Al matrix nanocomposites. Materials & Design (1980-2015), 2014. 54: p. 348-353; and Paknia, A., et al., Effect of size, content and shape of reinforcements on the behavior of metal matrix composites (MMCs) under tension. Journal of Materials Engineering and Performance, 2016. 25(10): p. 4444-4459 each of which is incorporated herein by reference in its entirety]. According to FIG. 6A, driving stress is a function of particle spacing, and it increases with the reduction in the particle size (leading to increased number of particles). According to Table 1 and FIG. 6A, the hardness value depends on the particle sizes of the ultra-hard phase, that is, cBN. The highest hardness value (1.78 GPa) is observed for the composition with 20 μm cBN particles. The hardness decreases with an increase in the cBN particle size and Al matrix grain size, which is in accordance with the Hall-patch relationship [Rice, R. W., C. C. Wu, and F. Boichelt, Hardness-grain-size relations in ceramics. Journal of the American ceramic society, 1994. 77(10): p. 2539-2553, which is incorporated herein by reference in its entirety].

cBN is known for its properties (similar to those of a diamond), such as high hardness, oxidation resistance, high thermal conductivity, and chemical inertness [McKie, A., et al., Mechanical properties of cBN-Al composite materials. Ceramics International, 2011. 37(1): p. 1-8; and Zhao, W., et al., Tribological performances of epoxy resin composite coatings using hexagonal boron nitride and cubic boron nitride nanoparticles as additives. Chemical Physics Letters, 2019. 732: p. 136646, each of which is incorporated herein by reference in its entirety]. The OCPs were recorded for pure Al and its composites with different particle sizes of cBN (20, 40, and 60 μm) in a 3.5 wt. % NaCl solution for 1 h. Referring to FIG. 7, the OCP becomes more negative with an increase in the cBN particle size in the Al matrix as compared to that of pure Al. The improved performance is obtained by adding 20 μm cBN particles with a potential of −622.8 mV. The addition of 40 and 60 μm cBN particles to pure Al results in the shift of OCP toward more negative potentials, i.e., −625.6 and −628.6 mV, respectively, which further indicates the high corrosion rate of these samples in comparison to that of the composite with 20 μm cBN particles.

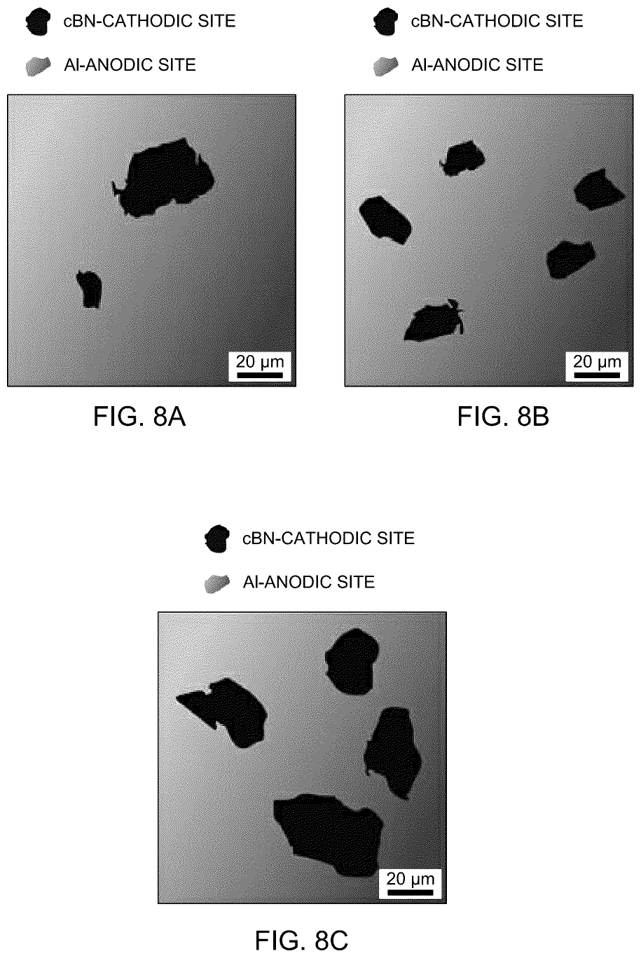

The development of galvanic interactions between the cBN reinforcement particles and the Al matrix is an important factor that accelerates corrosion. In the schematic graph shown in FIG. 8, cBN particles and the Al matrix act as cathodic and anodic sites, respectively. If the reinforcement particles are smaller in size, a relatively high cathodic current can be supported by the Al matrix [Pramanik, A., Developments in the non-traditional machining of particle reinforced metal matrix composites. International Journal of Machine Tools and Manufacture, 2014. 86: p. 44-61, which is incorporated herein by reference in its entirety], as illustrated in FIG. 8A; whereas increasing the particle size of cBN to 40 and 60 m, results in the development of larger cathodic and smaller anodic sites, eventually accelerating the corrosion between the matrix and reinforced interface [Dikici, B., F. Bedir, and M. Gavgali, The effect of high TiC particle content on the tensile cracking and corrosion behavior of Al-5Cu matrix composites. Journal of Composite Materials, 2020. 54(13): p. 1681-1690, which is incorporated herein by reference in its entirety], as shown in FIG. 8B and FIG. 8C.

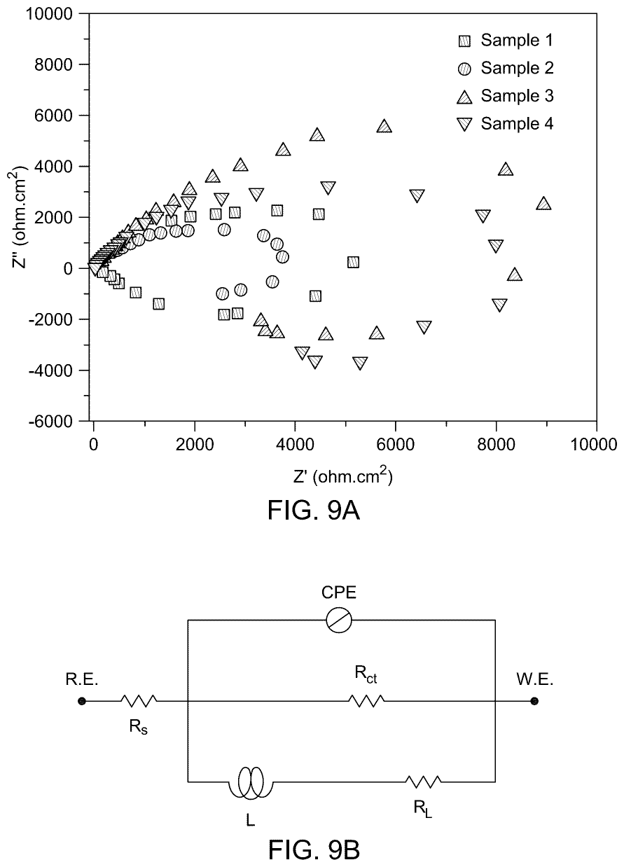

EIS measurements were performed to study the electrochemical behavior of cBN on the Al matrix toward pitting corrosion. The impedance response of Al-cBN composite in 3.5 wt. % NaCl is presented in the Nyquist plot in FIG. 9A, in which the imaginary part of the impedance (Z″) is plotted against the real part (Z′). The plot shows a capacitive loop at high frequencies and an inductive loop at low frequencies. The capacitive loop is associated with charge-transfer resistance and electric double-layer capacitance. The formation of an inductive loop in the Nyquist plot indicates the adsorption of large Cl⁻ anions at the surface of the specimen [Keddam, M., et al., Exfoliation corrosion of aluminum alloys examined by electrode impedance. Electrochimica Acta, 1997. 42(1): p. 87-97, which is incorporated herein by reference in its entirety]. Another reason for this observation could be the dissolution of cBN particles during the initial stages when they are in a corrosive environment [Bakkar, A. and V. Neubert, Corrosion characterization of alumina-magnesium metal matrix composites. Corrosion science, 2007. 49(3): p. 1110-1130, which is incorporated herein by reference in its entirety]. Additionally, the presence of an inductive loop is related to the pitting process [Acevedo-Hurtado, P. and P. Sundaram, Corrosion behavior of novel Al-Al₂O₃ composites in aerated 3.5% chloride solution. Journal of Materials Engineering and Performance, 2017. 26(1): p. 69-75, which is incorporated herein by reference in its entirety]. The pitting mechanism of Al alloys involves three steps: (1) the penetration and adsorption of Cl⁻ ions on the surface of the oxide layer; (2) the formation of hydroxychloride Al salt; and (3) the dissolution of the protective layer [Singh, I., et al., Influence of SiC particles addition on the corrosion behavior of 2014 Al—Cu alloy in 3.5% NaCl solution. Corrosion Science, 2009. 51(2): p. 234-241, which is incorporated herein by reference in its entirety].

An electrical equivalent circuit (EEC) is shown in FIG. 9B. Each component in this model has unique implications; Rₛ the solution resistance between the working and reference electrodes; R_{ct} indicates electron charge transfer resistance; the constant phase element (CPE) describes the non-ideal capacitive behavior of the electric double layer; n is the degree of deviation, where n=0 indicates an ideal resistor; n=1 indicates an ideal capacitor, and n=−1 indicates an ideal inductor. The degree of deviation and double-layer capacitance are independent frequency parameters. To understand the inductive response at a lower frequency, an inductance (L) and inductance resistance (R_{L}) were included in the model. Most electrochemical tests measure polarization resistance (Rₚ), which is defined as the ability of the specimen to resist oxidation at applied external potential [Darmiani, E., et al., Corrosion investigation of Al—SiC nano-composite fabricated by accumulative roll bonding (ARB) process. Journal of Alloys and Compounds, 2013. 552: p. 31-39, which is incorporated herein by reference in its entirety]. The higher the Rₚ, the better the corrosion resistance properties of the specimen [Murthy, H. A., V. B. Raju, and C. Shivakumara, Effect of TiN particulate reinforcement on corrosive behaviour of aluminium 6061 composites in chloride medium. Bulletin of Materials Science, 2013. 36(6): p. 1057-1066, which is incorporated herein by reference in its entirety].

TABLE 2
Impedance data of Al—cBN composites with increasing
cBN contents in pristine Al in a 3.5 wt. % NaCl solution.

| | Particle Size | Impedance Parameters | | | | | |
|---|---|---|---|---|---|---|---|
| Sample | of cBN in Al | Rₛ | R_{ct} | L | R_{L} | CPE | |
| ID | Matrix (μm) | (Ω · cm²) | (kΩ · cm²) | (kH · cm²) | (kΩ · cm²) | (μF/cm²) | n |
| 1 | 0 | 4.5 ± 0.1 | 5.2 ± 1.3 | 3.4 ± 1.3 | 0.3 ± 0.1 | 52 ± 2 | 0.78 ± 0.03 |
| 2 | 20 | 4.4 ± 0.1 | 1.6 ± 0.04 | 5.7 ± 0.7 | 4.1 ± 0.01 | 268 ± 5 | 0.68 ± 0.01 |
| 3 | 40 | 4.2 ± 0.1 | 8.5 ± 1.2 | 1.6 ± 0.1 | 0.2 ± 0.1 | 168 ± 7 | 0.67 ± 0.1 |
| 4 | 60 | 4.6 ± 0.2 | 7.3 ± 1.3 | 2.2 ± 0.2 | 0.2 ± 0.03 | 106 ± 4 | 0.88 ± 0.02 |

Generally, the value of Rₚ is lower for composite materials and increases as the percentage of reinforcement increases because of the formation of phase (such as carbide or intermetallic) at the matrix and reinforcement interface. The Rₛ were calculated from Nyquist plots for pure Al and Al-cBN composites. The values are listed in Table 2, which demonstrates that the cBN addition to the Al matrix increases the Rₛ to a certain level, which emphasizes good corrosion resistance properties. Moreover, in a corrosive environment, the cBN addition results in higher Rct values and lower CPE values [Kamel, M., et al., Electrodeposition of Ni—Co/nano Al₂O₃ composite coating on low carbon steel and its characterization. Int. J. Electrochem. Sci, 2020. 15: p. 6343-6358, which is incorporated herein by reference in its entirety].

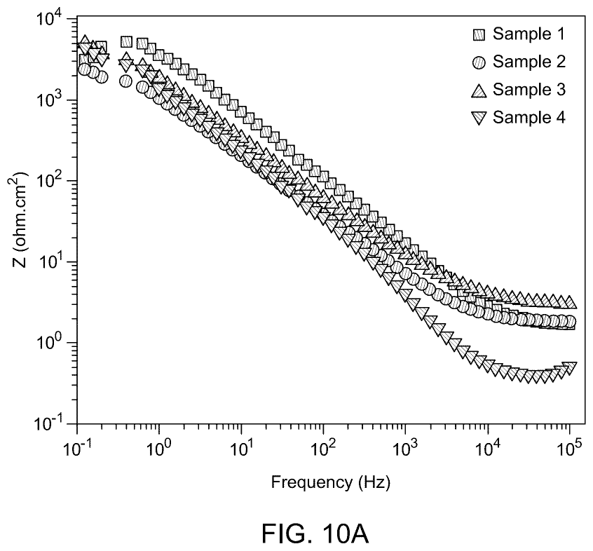

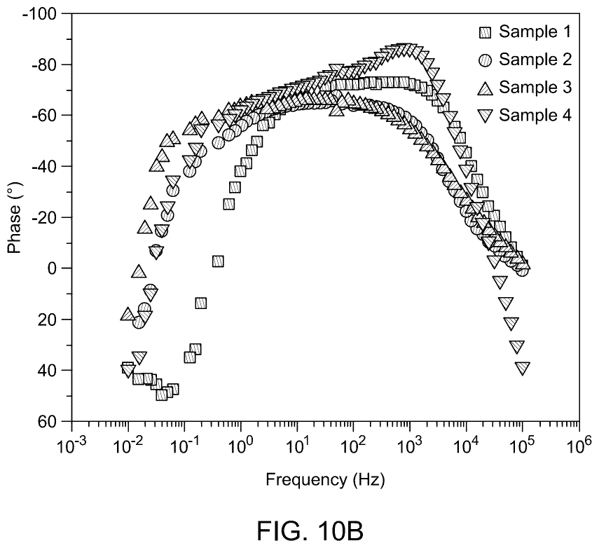

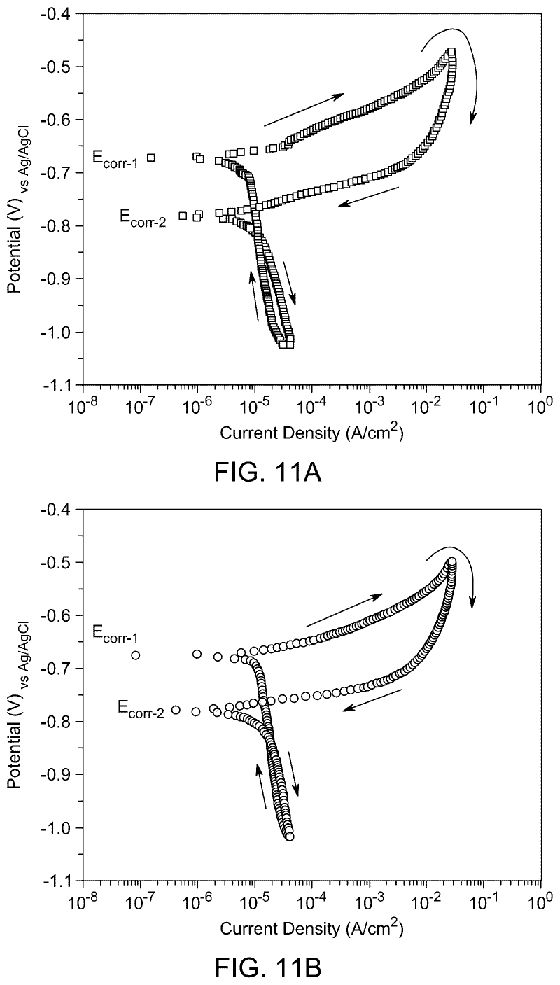

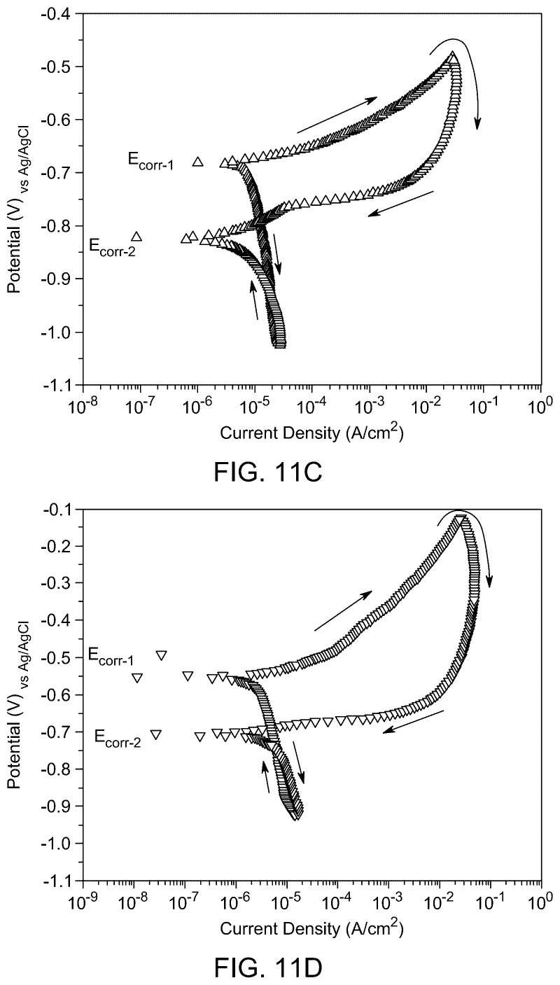

Compared to the Nyquist plot, the Bode plot has the advantage of obtaining valuable information owing to its simultaneous analysis of impedance (Z) and phase angle (θ) with respect to frequency (f). FIG. 10A and FIG. 10B show the Bode plot (in terms of Z and θ) for all the test specimens (samples 1-4). Three main characteristics of the Bode plot determine the localized corrosion behavior: (a) the reduction of impedance in the capacitive region, (b) the change in frequency dependence at extremely low frequencies, and (c) the occurrence of second phase angle maxima. The Bode plots demonstrate that the impedance modulus increases at lower frequencies as the particle size of cBN in the Al matrix increases, as shown in FIG. 10A. However, at higher frequencies, the composites with cBN particle sizes of 20 and 40 m show a higher impedance modulus than the 60 m in the Al-cBN composite. FIG. 10B shows that the maximum phase angle (θₘₐₓ) exists between −65° and −86°, which further reveals the non-ideal capacitive nature of both the pure Al and Al-cBN composites. The CPP technique was utilized to study the pitting corrosion of pure Al (FIG. 11A) and its composites (FIG. 11B-FIG. 11D) in a 3.5 wt. % NaCl solution.

The corrosion potential (E_{corr}), corrosion current density (i_{corr}), pitting potential (Eₚᵢₜ), corrosion rate (C_{R}), and Tafel slopes (βₐ and β_{c}) were obtained from the CPP curves. The specimens containing cBN particles show a more negative E_{corr}, as listed in Table 3A and Table 3B, which further indicates the thermodynamic instability of the material in a corrosive environment with a high C_{R} [Wang, X., et al., Corrosion behavior of Al₂O₃-reinforced graphene encapsulated Al composite coating fabricated by low pressure cold spraying. Surface and Coatings Technology, 2020. 386: p. 125486, which is incorporated herein by reference in its entirety]. However, the C_{R} of Al-cBN composite with a particle size of 20 m is lower than that of pure Al. The Eₚᵢₜ value became slightly negative by adding cBN particles into the Al matrix.

TABLE 3A
Different electrochemical parameters obtained from Tafel fit.

| | cBN | | | | | |
|---|---|---|---|---|---|---|
| | content | Tafel Fit | | | | |
| Sample | in Al | i_{corr} | | | | |
| ID | (μm) | (μA cm²) | E_{corr}(mV) | C_{R}(mpy) | βa(V/decade) | βc(V/decade) |
| 1 | 0 | 6 ± 0.2 | −672 ± 16 | 6.4 ± 0.2 | 28 ± 1 | 224 ± 4 |
| 2 | 20 | 4 ± 0.1 | −622 ± 17 | 5 ± 0.1 | 71 ± 0.5 | 172 ± 5 |
| 3 | 40 | 9 ± 0.3 | −626 ± 16 | 11 ± 0.3 | 18 ± 0.1 | 198 ± 7 |
| 4 | 60 | 7.9 ± 0.2 | −629 ± 18 | 8 ± 0.2 | 39 ± 1 | 201 ± 3 |

TABLE 3A
Different electrochemical parameters obtained from CPP curves.

| | cBN | | | | |
|---|---|---|---|---|---|
| | content | CPP | | | |
| Sample | in | i_{corr} | Eₚᵢₜ (mV vs | E_{corr1} (mV vs | Eₚᵢₜ-E_{corr1} (mV |
| ID | Al (μm) | (μA/cm²) | Ag/AgCl) | Ag/AgCl) | vs Ag/AgCl) |
| 1 | 0 | 5 ± 0.2 | −634 ± 19 | −653 ± 20 | 19.4 ± 1 |
| 2 | 20 | 4 ± 0.1 | −656 ± 19 | −681 ± 20 | 25 ± 0.7 |
| 3 | 40 | 8. ± 0.1 | −659 ± 20 | −682 ± 21 | 23 ± 0.7 |
| 4 | 60 | 6 ± 0.2 | −564 ± 17 | −584 ± 17 | 20.0 ± 0.6 |

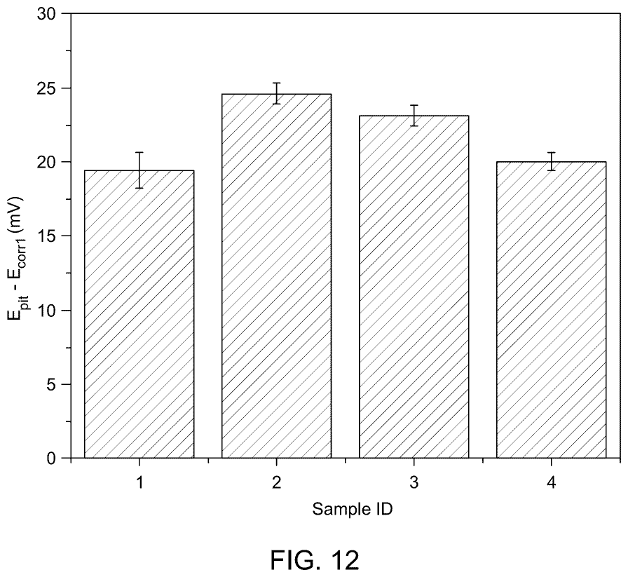

In cyclic polarization studies, when scanning toward positive potentials, a stable pit generally starts to grow when the potential reaches Eₚᵢₜ where the current increases sharply from the passive current level. Both pure Al and cBN-based Al composite materials exhibit a positive hysteresis loop, which indicates the difficulty of preventing the initiation of pits. A larger positive hysteresis shows greater difficulty reestablishing the damaged layer [Liu, Y., et al., Understanding pitting corrosion behavior of AZ91 alloy and its MAO coating in 3.5% NaCl solution by cyclic potentiodynamic polarization. Journal of Magnesium and Alloys, 2022. 10(5): p. 1368-1380, which is incorporated herein by reference in its entirety]. The largest positive hysteresis loop is determined for the 40 m Al-cBN composite. The difference between the Eₚᵢₜ and E_{corr} values provides beneficial information regarding the tendency of the material to develop pits. A more significant difference between these values shows that the material is more resistant to pitting corrosion and further demonstrates the protection level of the material in a corrosive environment [Pardo, A., et al., Influence of reinforcement proportion and matrix composition on pitting corrosion behaviour of cast aluminium matrix composites (A3xx. x/SiCp). Corrosion Science, 2005. 47(7): p. 1750-1764, which is incorporated herein by reference in its entirety]. FIG. 12 shows the differences in Eₚᵢₜ and E_{corr} values observed for each material in a 3.5 wt. % NaCl solution for 1 h.

A favorable combination of properties is obtained for the composite with the cBN particle size of 20 μm, exhibiting densification, elastic modulus, and hardness values of 98.1% (2.65 g/cm³ density), 76.1 GPa, and 1.78 GPa, respectively, along with the lowest corrosion rate (4.533 mpy) at room temperature (Table 4). Additionally, the above observations show that a high degree of consolidation was achieved using fine-sized cBN particles with a constant weight (10 wt. % cBN and 90 wt. % Al) and volume percentage (12 vol. % cBN and 88 vol. % Al). Furthermore, mechanical and electrochemical properties improvements are expected to be beneficial for wear-resistant composite and lightweight applications (in the ground transportation industry), such as diesel engine piston crowns, connecting rods, and other components with optimal weight and cost efficiency [Chawla, N. and K. Chawla, Metal-matrix composites in ground transportation. JoM, 2006. 58(11): p. 67-70, which is incorporated herein by reference in its entirety]. Therefore, the as-developed Al-MMCs can endure high mechanical loads with good electrochemical resistance and save weight for potential automotive, aerospace, and other engineering applications [Koli, D. K., G. Agnihotri, and R. Purohit, Advanced aluminium matrix composites: the critical need of automotive and aerospace engineering fields. Materials Today: Proceedings, 2015. 2(4-5): p. 3032-3041, which is incorporated herein by reference in its entirety].

TABLE 4
Electrochemical and mechanical properties of the samples
sintered at 550° C. Samples IDs are according to Table 1.

| | cBN particle size | | | | Elastic | Corrosion |
|---|---|---|---|---|---|---|
| Sample | in Al matrix | Hardness | Density | Densification | Modulus | Rate |
| ID | (μm) | (GPa) | (g/cm³) | (%) | (GPa) | (mpy) |
| 1 | 0 | 0.69(1) | 2.68 | 99.3 | 69.8(1) | 6.4 ± 0.2 |
| 2 | 20 | 1.78(2) | 2.65 | 98.1 | 76.1(8) | 5 ± 0.1 |
| 3 | 40 | 1.49(2) | 2.58 | 95.6 | 73.2(3) | 11 ± 0.3 |
| 4 | 60 | 1.40(1) | 2.55 | 94.4 | 71.1(5) | 8 ± 0.2 |

To conclude, Al-cBN composites were developed with different reinforcement particle sizes using SPS at a sintering temperature of 550° C. The microstructure, elastic modulus, density, hardness, and corrosion resistance of the Al-cBN composites were evaluated. With the increase in the cBN particle size, the properties mentioned above degraded, and a favorable combination of properties was obtained for the composite with 20 μm cBN particles. By maintaining a constant weight composition and reducing the particle size (i.e., increased number of particles in the matrix), reinforcement provides better strength and stress drive to the overall matrix, leading to an improvement in the mechanical and electrochemical performance. On the other hand, the presence of larger cBN particles in the Al matrix resulted in a higher corrosion rate due to galvanic interactions between the reinforcement particles and the matrix. Herein, the 20 μm Al-cBN composite exhibited an improved polarization resistance. Additionally, it possessed the lowest corrosion rate and a lower tendency for pit formation in a corrosive environment compared to the other tested samples. Therefore, the Al-cBN composite of the present disclosure exhibits a favorable and promising combination of mechanical and electrochemical properties and significant potential for industrial applications requiring lightweight materials.

Numerous modifications and variations of the present disclosure are possible in light of the above teachings. It is, therefore, to be understood that within the scope of the appended claims, the invention may be practiced otherwise than as specifically described herein.

1: A method of making an aluminum-cubic boron nitride (Al-cBN) composite, comprising:
mixing an aluminum powder and particles of cubic boron nitride (cBN) in a solvent and sonicating to form an Al-cBN mixture;
drying the Al-cBN mixture to form a dried mixture powder;
sintering by pressing and heating the dried mixture powder to form the Al-cBN composite;
wherein the aluminum powder has an average particle size of 10 to 100 micrometers (μm);
wherein the cBN particles have an average particle size of from 10 to 100 μm; and
wherein the cBN particles are uniformly dispersed throughout the Al-cBN composite.

2: The method of claim 1, wherein the aluminum powder has an average particle size of about 50 μm.

3: The method of claim 1, wherein the cBN particles having a cubic or octahedral shape, and an average particle size of from 20 to 60 μm.

4: The method of claim 1, having a network matrix of aluminum; wherein the cBN particles are uniformly dispersed throughout the network matrix of aluminum.

5: The method of claim 1, wherein the solvent is at least one alcohol selected from the group consisting of methanol, ethanol and propanol.

6: The method of claim 1, wherein a weight ratio of the aluminum powder to the cBN particles is in a range of from 100:1 to 5:1.

7: The method of claim 1, wherein the pressing is performed under a uniaxial pressure in a range of 30 to 70 megaPascals (MPa).

8: The method of claim 1, wherein the heating is performed at a temperature in a range of 500 to 600° C.

9: The method of claim 1, wherein during the sintering, the aluminum powder and the cBN particles in the dried mixture do not react.

10: The method of claim 1, wherein the Al-cBN composite has an average hardness in a range of 1 to 2 gigaPascals (GPa);

11: The method of claim 1, wherein the Al-cBN composite has an average elastic modulus in a range of 70 to 80 GPa.

12: The method of claim 1, wherein the Al-cBN composite has a density in a range of 2.5 to 2.7 grams per cubic centimeter (g/cm³).

13: The method of claim 1, wherein the Al-cBN composite has a densification in a range of 94 to 99% based on a density of the aluminum powder.

14: A light weight material comprising the Al-cBN composite prepared by the method of claim 1, wherein a weight ratio of the aluminum powder to the cBN particles is about 9:1, and wherein the cBN particles have an average particle size of from 20 to 60 μm.

15: The light weight material of claim 14, having a density in a range of 2.55 to 2.65 g/cm³.

16: The light weight material of claim 14, which is at least part of a cutting tool, an abrasive tool, mold, die, break-ring, nozzle, glass forming tool, metal forming refractory tool, high temperature refractory shape, furnace vent, furnace stack, furnace fixture, generator component, reactor component, turbine component, engine component, vehicular component, aerospace component, ship, submarine component, aircraft component, weapon, or armor.

17: The light weight material of claim 14, which when exposed to a salt solution has a corrosion rate in a range of from 4 to 35 mils per year (mpy).

18: The light weight material of claim 17, wherein the salt solution comprises at least one salt selected from the group consisting of sodium chloride, potassium chloride, magnesium chloride, magnesium sulfate, calcium sulfate, calcium carbonate, and sodium bicarbonate.

19: The light weight material of claim 17, wherein the salt is present in the salt solution at a concentration of 1 to 8% by weight.

20: The light weight material of claim 17, having a corrosion current density (i_{corr}) of 3 to 30 microamperes square centimeters (μA cm²) under a potential of −1.0 to 0 V (vs Ag/AgCl).
